(19) United States
(12) Patent Application Publication
(10) Pub. No.: US 2022/0212506 A1
(43) Pub. Date: Jul. 7, 2022

(54) PNEUMATIC TIRE AND MANUFACTURING METHODS THEREFOR

(71) Applicant: Sumitomo Rubber Industries, Ltd., Kobe-shi (JP)

(72) Inventor: Hiroshi KAWABATA, Kobe-shi (JP)

(73) Assignee: Sumitomo Rubber Industries, Ltd., Kobe-shi (JP)

(21) Appl. No.: 17/559,413

(22) Filed: Dec. 22, 2021

(30) Foreign Application Priority Data
Jan. 6, 2021 (JP) 2021-001067

(51) Int. Cl. B60C 15/00; B60C 9/02; B29D 30/32

(52) U.S. Cl. CPC B60C 15/0018; B60C 9/0238; B60C 2015/0621; B60C 2009/0253; B29D 30/32

(57) ABSTRACT

A pneumatic tire comprises a tread portion, sidewall portions, bead portions each with a bead core embedded therein, and a carcass extending between the bead portions and comprising first carcass cords and second carcass cords. The first carcass cord comprises: a main portion extending from the tread portion to the bead portions via the sidewall portions; and folded-back portions continued from the main portion and folded back around the bead cores from the inside to the outside in the tire axial direction. The second carcass cord extends from the tread portion to the bead portions and terminates on the axially outside of the folded-back portions of the first carcass cords. Young's modulus of the second carcass cords is larger than Young's modulus of the first carcass cords.

### BACKGROUND OF THE INVENTION

### Field of the Invention

The present disclosure relates to a pneumatic tire and a methods for manufacturing the same.

### Background Art

Conventionally, there has been known a technique for improving running performance of a vehicle by using downforce based on the aerodynamic characteristics of the vehicle. In order to take advantage of such downforce, it is preferred that the tires exert high vertical spring rigidity, namely, stiffness in the tire radial direction.

Patent Document 1 below discloses a tire having a high vertical spring rigidity increased by a first carcass ply and a second carcass ply.
Patent Document 1: Japanese Patent Application Publication No. 2020-083053

### SUMMARY OF THE INVENTION

### Problems to be Solved by the Invention

In the conventional tires, the vertical spring rigidity is increased by increasing the tire inner pressure and increasing the rigidity of the carcass. According to such techniques, the flexibility of the tire at relatively light tire load becomes insufficient. As a result, the ground contact length and ground contact area of the tire are reduced, and thereby tire performance based on the ground contact are degraded.

The present disclosure was made in view of the above circumstances, and a primary objective of the present disclosure is to provide a pneumatic tire capable of exerting high vertical spring rigidity while ensuring the ground contact at light tire loads.

### Means for Solving the Problems

According to the present disclosure, a pneumatic tire comprises a tread portion, a pair of sidewall portions, a pair of bead portions each with a bead core embedded therein, and a carcass extending between the bead portions and comprising first carcass cords and second carcass cords, wherein

each of the first carcass cords comprises a main portion extending from the tread portion to the bead portions via the sidewall portions, and folded-back portions continued from the main portion and folded back around the bead cores from the inside to the outside in the tire axial direction,

each of the second carcass cords extends from the tread portion to the bead portions and terminates on the axially outside of the folded-back portions of the first carcass cords, and

the first carcass cords have a Young's modulus, and the second carcass cords have a Young's modulus larger than the Young's modulus of the first carcass cords.

### Effects of the Invention

In the pneumatic tire according to the present disclosure, when a vertical load is applied to the pneumatic tire, compressive stress is generated in an axially inner part of each sidewall portion, and tensile stress is generated in an axially outer part of each sidewall portion.

Since the Young's modulus of the second carcass cords located on the axially outside is larger than the Young's modulus of the first carcass cords located on the axially inside, the vertical spring rigidity at heavy tire load is improved.
On the other hand, when the tire load is light, the tensile stress generated in the axially outer part of each sidewall portion is small, so the influence of the second carcass cords on the vertical spring rigidity is limited, and sufficient ground contact can be achieved.

### DESCRIPTION OF THE DRAWINGS

FIG. 1 is a meridian cross-sectional view of a pneumatic tire as an embodiment of the present disclosure.

FIG. 2 is an enlarged cross-sectional view showing the pneumatic tire of FIG. 1.

FIG. 3 is a cross-sectional view schematically showing the stress generated in the sidewall portion of the pneumatic tire to which the vertical load is applied.

FIG. 4 is a cross-sectional view of the sidewall portion provided with an insulation rubber layer.

FIG. 5 is a flowchart showing a method for manufacturing the pneumatic tire shown in FIG. 1.

### DETAILED DESCRIPTION OF THE INVENTION

Embodiments of the present disclosure will now be described in detail in conjunction with accompanying drawings.

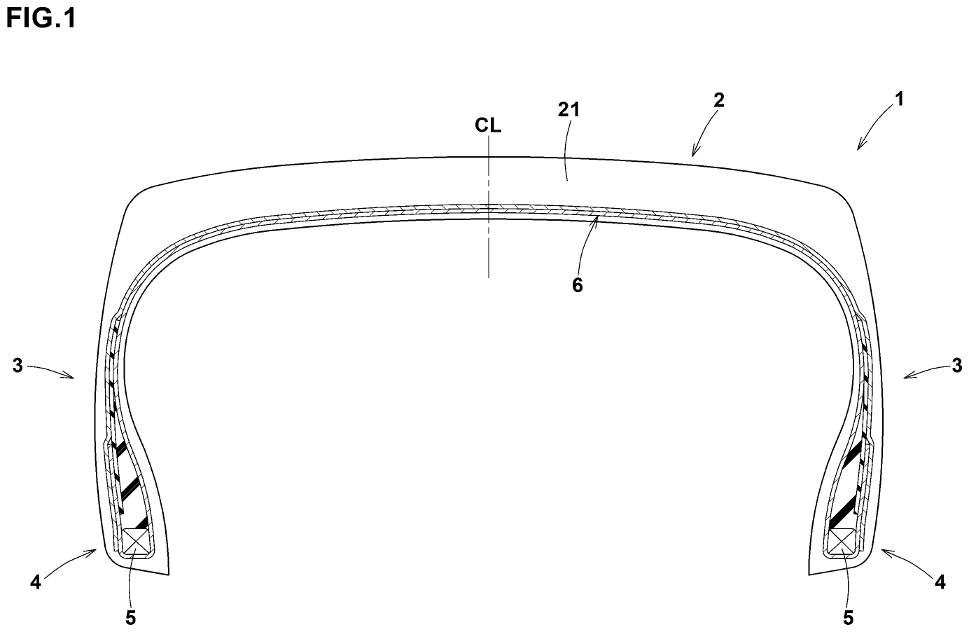

FIG. 1 is a meridian cross-sectional view including the tire rotational axis of a pneumatic tire 1 as an embodiment under its normal state.

The normal state of a tire is such a state that the tire is mounted on a standard wheel rim (not shown), inflated to a normal inner pressure, and loaded with no tire load.

In this application, dimensions and the like of various tire portions refer to values measured under the normal state unless otherwise noted.

The standard wheel rim is a wheel rim specified for the tire by a standard included in a standardization system on which the tire is based, for example, the “normal wheel rim” in JATMA, “Design Rim” in TRA, and “Measuring Rim” in ETRTO.

The normal inner pressure is air pressure specified for the tire by a standard included in a standardization system on which the tire is based, for example, the “maximum air pressure” in JATMA, maximum value listed in the “TIRE LOAD LIMITS AT VARIOUS COLD INFLATION PRESSURES” table in TRA, and “INFLATION PRESSURE” in ETRTO.

If there is no applicable standard such as racing tires, a wheel rim and air pressure recommended by the tire manufacturer are applied as the normal rim and the normal inner pressure, respectively.

The pneumatic tire 1 comprises a tread portion 2, a pair of sidewall portions 3, a pair of bead portions 4 each with a bead core 5 embedded therein, and a carcass 6 extending between the pair of bead portions 4.

The tread portion 2 is provided with a tread rubber 21 disposed radially outside the carcass 6.

Between the carcass 6 and the tread rubber 21, a belt for reinforcing the tread portion 2 may be provided.

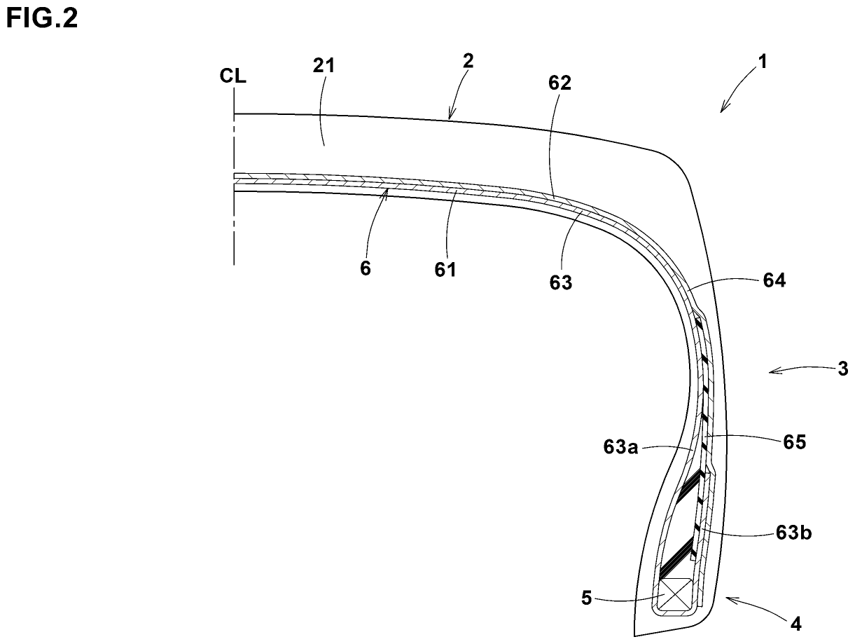

FIG. 2 shows the pneumatic tire 1 on one side with respect to the tire equator CL.

The carcass 6 comprises a first carcass ply 61 and a second carcass ply 62 disposed radially outside the first carcass ply 61.

On the inside of the first carcass ply 61, an inner liner made of a rubber compound having excellent air permeability may be provided.

The first carcass ply 61 is composed of first carcass cords 63 arranged along the tire radial direction and the tire axial direction and coated with a topping rubber.

The second carcass ply 62 is composed of second carcass cords 64 arranged along the tire radial direction and the tire axial direction and coated with a topping rubber.

The first carcass cord 63 comprises a main portion 63a and a pair of folded-back portions 63b continued from the main portion 63a. The main portion 63a reaches the bead portions 4 from the tread portion 2 through the sidewall portions 3.

The folded-back portions 63b are folded back around the respective bead core 5 in the bead portions from the inside to the outside in the tire axial direction. The folded-back portions 63b terminate, for example, in the vicinity of the maximum tire width portion.

The second carcass cord 64 extends from the tread portion 2 through the sidewall portions 3, and reaches the bead portions 4 to terminate on the axially outside of the folded-back portions 63b of the first carcass cords 63.

The first carcass ply 61 is a so-called turnup ply, and the second carcass ply 62 is a so-called turn-down ply not turned up around the bead core.

The first carcass cords 63 have a Young's modulus E1, and the second carcass cords 64 have a Young's modulus E2.

In the present disclosure, the Young's modulus E2 is larger than the Young's modulus E1.

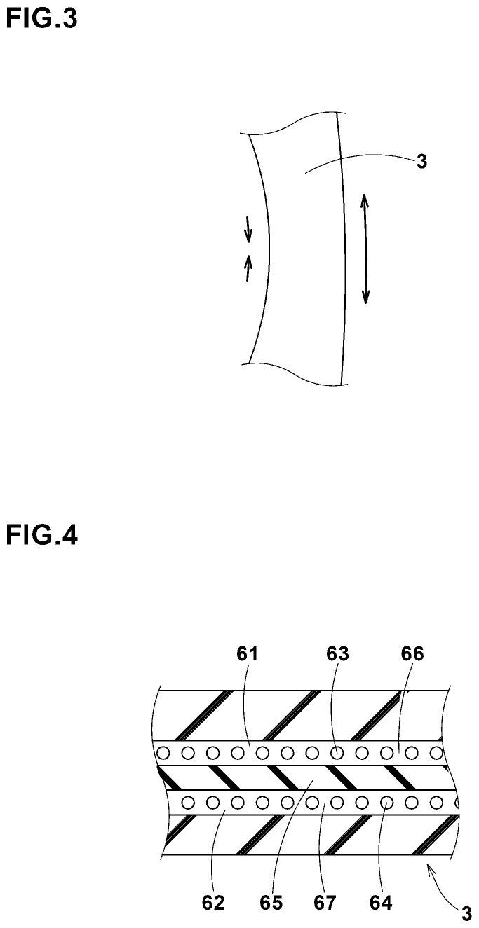

FIG. 3 schematically shows the stress generated in the sidewall portion 3 of the pneumatic tire 1 to which a vertical load is applied. When a vertical load is applied to the pneumatic tire 1, each sidewall portion 3 is bent and deformed so that compressive stress is generated in an axially inner part of the sidewall portion 3, and tensile stress is generated in an axially outer part of the sidewall portion 3.

In the present disclosure, since the Young's modulus E2 of the second carcass cords 64 located in the axially outer part of the sidewall portion 3 is larger than the Young's modulus E1 of the first carcass cords 63 located in the axially inner part of the sidewall portion 3, the vertical spring rigidity when the tire load is high is improved.

In the top category racing cars, the air flowing under the car is utilized in order to increase the vertical load on the tires and thereby to increase the grip force and improve the running performance.

When such a racing car is running at a high speed, a large downforce is generated.
If the distance between the road surface and the bottom panel of the car fluctuates, the downforce is also fluctuated, and thereby the running performance is deteriorated.
Further, if the posture of the car is changed due to the vehicle load fluctuation during acceleration and deceleration, then the downforce is changed between the front and rear of the car. This also deteriorates the running performance.

In the pneumatic tire 1 according to the present disclosure, high vertical spring rigidity can be obtained at heavy tire load. Therefore, the vehicle posture and distance between the road surface and the bottom panel of the car become stable during high speed running. As a result, the large downforce can be obtained stably to improve the running performance.

On the other hand, in a low speed range, for example, when running a hairpin curve, the downforce is significantly reduced, and thereby the tire load is significantly reduced. Therefore, the deflection deformation of the sidewall portions 3 is reduced, and the tensile stress generated in the outer part of the sidewall portion 3 becomes small. As a result, the effect of the second carcass cords having the larger Young's modulus E2 on the vertical spring rigidity of the pneumatic tire 1 is limited. Thus, in the pneumatic tire 1 according to the present disclosure, the sidewall portions 3 are flexibly bent even in a light tire load range to ensure sufficient ground contact, and the running performance of the vehicle can be effectively improved.

Further, even if the vertical tire load is reduced by acceleration/deceleration (namely, that of the front tire during acceleration, and that of the rear tire during deceleration), the change in the ground contact area and length of the tire is limited, and thereby, the deterioration of the running performance can be effectively prevented.

Preferably, the Young's modulus E2 of the second carcass cords 64 is not less than 1.5 times but not more than 2.5 times the Young's modulus E1 of the first carcass cords 63. As a result, sufficient bending deformation of the sidewall portions 3 can be secured, and good durability performance can be obtained.

In the pneumatic tire 1, as the Young's modulus E2 of the second carcass cords 64 is larger than the Young's modulus E1 of the first carcass cords 63, a rigidity difference occurs therebetween.

Therefore, in the present embodiment, an insulation rubber layer 65 is preferably disposed between the second carcass cords 64 and the main portions 63a of the first carcass cords 63 as shown in FIG. 2.
The insulation rubber layer 65 functions as a cushioning member between the main portions 63a of the first carcass cords 63 and the second carcass cords 64, and suppresses damage to the carcass 6 due to the rigidity difference.

FIG. 4 is a cross-sectional view of the sidewall portion 3 including the insulation rubber layer 65 taken along the tire circumferential direction. In the figure, the hatching showing the cross section of the first carcass cords 63 and the second carcass cords 64 is omitted.

The insulation rubber layer 65 is a different rubber compound from the first topping rubber 66 covering the first carcass cords 63 and the second topping rubber 67 covering the second carcass cords 64.

It is preferable that the radially outer end of the insulation rubber layer 65 is located radially outside the radially outer ends of the folded-back portions 63b as shown in FIG. 2. As a result, damage to the carcass 6 can be suppressed on the radially outside of the radially outer ends of the folded-back portions 63b (for example, in a buttress portion which is greatly deformed when a load is applied).

It is preferable that the radially inner end of the insulation rubber layer 65 is located radially inside the radially outer ends of the folded-back portions 63b.

As a result, in the vicinity of the radially outer ends of the folded-back portions 63b, damage to the carcass 6 is suppressed.

It is preferable that the insulation rubber layer 65 is disposed axially inside the folded-back portions 63b.

As a result, the folded-back portions 63b are located in an axially outer part of the bead portion 4, so the vertical rigidity of the bead portion 4 when applied by a heavy load, is improved.

The insulation rubber layer 65 may be omitted.

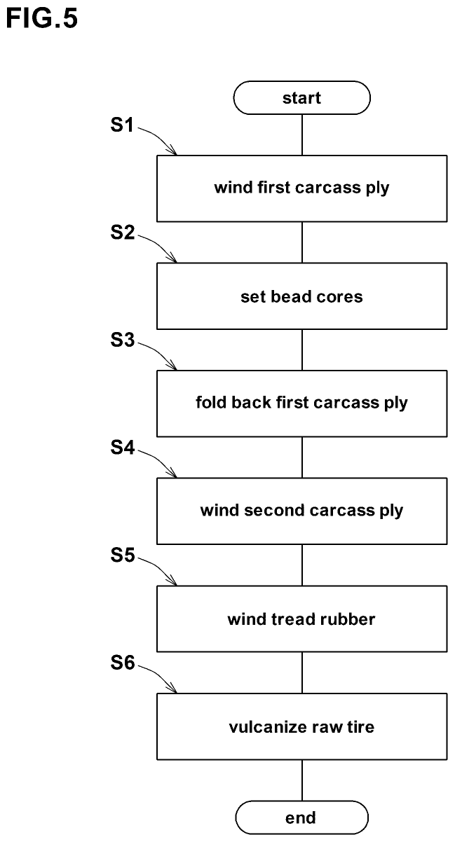

FIG. 5 is a flowchart showing the procedure of a manufacturing method 100 of the pneumatic tire 1.

The method 100 for manufacturing the pneumatic tire 1 comprises:

a first step S1 of winding the first carcass ply 61 into a cylindrical shape,
a second step S2 of setting the bead cores 5,
a third step S3 of folding back the folded-back portions 63b of the first carcass cords 63, and
a fourth step S4 of winding the second carcass ply 62.

In the first step S1, the first carcass ply 61 comprising the first carcass cords 63 is wound around, for example, a cylindrical outer peripheral surface of a tire building drum.

In the second step S2, the annular bead cores 5 are disposed on the radially outside of the cylindrically-wound first carcass ply 61.

The bead cores 5 are respectively disposed axially inside the axial outer ends of the first carcass ply 61.
As a result, in the first carcass cords 63, the axially outer portion than each bead core 5 becomes the folded-back portion 63b.

In the third step S3, the folded-back portions 63b in the first carcass ply 61 are folded toward the radially outside along the respective bead cores 5. The insulation rubber layer 65 is wound around the cylindrically-wound first carcass ply 61 before the third step S3 is performed.

In the fourth step S4, the second carcass ply 62 is wound around the radially outer side of the cylindrically-wound first carcass ply 61.

As described above, the second carcass cords 64 constituting the second carcass ply 62 have a higher Young's modulus than that of the first carcass cords 63 constituting the first carcass ply 61.

The manufacturing method 100 of the pneumatic tire 1 may comprise the following fifth and sixth steps.

The fifth step S5 is to wind the tread rubber 21 around the radially outer side of the second carcass ply 62. Thereby, the raw tire is formed.

The sixth step S6 is to vulcanization-mold the raw tire in a mold. In the sixth step S6, preferably, the tread rubber 21 is stretched by 2% to 4% in the tire circumferential direction. Thereby, interference between the tread rubber 21 and the mold during vulcanization-molding is suppressed, and deformation of the tread portion 2 is suppressed.

In the present embodiment, the first carcass cords 63 wound in the first step S1 have a smaller Young's modulus than the second carcass cords 64 wound in the fourth step S4, so the movement of the first topping rubber 66 and the inner liner rubber during vulcanization-molding is suppressed, and the occurrence of open threads is suppressed.

Usually, the innermost carcass cords are covered with a certain thickness of the inner liner rubber which forms the inner surface of the tire. However, there is a possibility that the thickness is reduced during vulcanization-molding the tire for various reasons so that the innermost carcass cords become almost exposed in the inner surface of the vulcanized tire. This phenomenon is called “open thread”, and may adversely affect the tire durability.

While detailed description has been made of a preferable embodiment of the present disclosure, the present disclosure can be embodied in various forms without being limited to the illustrated embodiment.

### Comparison Tests

Based on the structure shown in FIG. 1, pneumatic tires of size 330/710R18 were experimentally manufactured as test tires (Comparative Example tires Ref. 1-Ref. 2 and Working example tires Ex. 1-Ex. 5). The angle of the carcass cords of each test tire was 90 degrees with respect to the tire circumferential direction. Specifications of the test tires are shown in Table 1.

Each test tire was tested for various performances as follows.

### <Occurrence of Open Thread>

For each test tire, a hundred samples were manufactured and visually checked whether the open thread phenomenon was occurred or not. The results are shown in Table 1.

### <Durability>

Using a drum-type tire testing machine, each test tire was tested for high-speed durability. The results are indicated in Table 1 by an index based on Comparative Example tire Ref.1 being 100, wherein the larger the value, the better the durability performance.

### <Ground Contact Length>

Each tire was measured for the static ground contact length at a light vertical tire load of 2 kN, and that at a heavy vertical tire load of 8 kN.
The results are indicated in Table 1 by an index based on Comparative Example tire Ref.1 being 100.

### <Cornering Force>

Using a flat-belt-type tire testing machine, each test tire was measured for a cornering force at the light vertical tire load of 2 kN, and that at the heavy vertical tire load of 8 kN under the following test conditions: slip angle of 4 degrees, camber angle of 0 degree, and running speed of 60 km/h.
The results are indicated in Table 1 by an index based on Comparative Example tire Ref.1 being 100, wherein the larger the value, the better the cornering performance.

### <Dynamic Rolling Radius>

Using the flat-belt-type tire testing machine, each test tire was measured for the dynamic rolling radius at the light vertical tire load of 2 kN, and that at the heavy vertical tire load of 8 kN under the following test conditions: camber angle of 0 degree, and running speed of 60 km/h.
The results are indicated in Table 1 by an index based on Comparative Example tire Ref.1 being 100.

TABLE 1

| tire | Ref. 1 | Ref. 2 | Ex. 1 | Ex. 2 | Ex. 3 | Ex. 4 | Ex. 5 |
|---|---|---|---|---|---|---|---|
| Young's modulus E1(N/sq · mm) | 1335 | 2670 | 1335 | 1335 | 1335 | 1335 | 1335 |
| Young's modulus E2(N/sq · mm) | 1335 | 2670 | 2003 | 2670 | 3338 | 4005 | 3338 |
| E2/E1 | 1.0 | 1.0 | 1.5 | 2.0 | 2.5 | 3.0 | 2.5 |
| insulation rubber | absent | absent | present | present | present | present | absent |
| open thread | none | caused | none | none | none | none | none |
| durability | 100.0 | 85.0 | 112.0 | 112.0 | 112.0 | 106.0 | 100.0 |
| ground contact length(%) | | | | | | | |
| light load | 100.0 | 96.0 | 100.0 | 100.0 | 100.0 | 100.0 | 100.0 |
| heavy load | 100.0 | 96.0 | 98.0 | 96.0 | 95.0 | 94.0 | 95.0 |
| CF (%) | | | | | | | |
| light load | 100.0 | 98.0 | 100.0 | 100.0 | 100.0 | 100.0 | 100.0 |
| heavy load | 100.0 | 102.0 | 101.0 | 101.5 | 102.0 | 103.0 | 102.0 |
| dynamic rolling radius(%) | | | | | | | |
| light load | 100.0 | 105.5 | 100.0 | 100.0 | 100.0 | 100.0 | 100.0 |
| heavy load | 100.0 | 104.5 | 102.3 | 105.1 | 107.7 | 110.1 | 107.7 |
| variation | 100.0 | 95.8 | 97.0 | 93.5 | 90.2 | 87.1 | 90.2 |

From the test results, it was confirmed that, in the working example tires, as compared with the comparative example tires, the variation of the dynamic rolling radius was reduced without deteriorating the cornering force at light tire loads as shown in Table 1.

### STATEMENT OF THE PRESENT DISCLOSURE

The present disclosure is as follows:—

Disclosure 1: A pneumatic tire comprising a tread portion, a pair of sidewall portions, a pair of bead portions each with a bead core embedded therein, and a carcass extending between the bead portions and comprising first carcass cords and second carcass cords,

wherein

each of the first carcass cords comprises a main portion extending from the tread portion to the bead portions via the sidewall portions, and folded-back portions continued from the main portion and folded back around the bead cores from the inside to the outside in the tire axial direction,

each of the second carcass cords extends from the tread portion to the bead portions and terminates on the axially outside of the folded-back portions of the first carcass cords,

the first carcass cords have a Young's modulus, and

the second carcass cords have a Young's modulus larger than the Young's modulus of the first carcass cords.

Disclosure 2: The pneumatic tire according to Disclosure 1, wherein

the Young's modulus of the second carcass cords is 1.5 to 2.5 times the Young's modulus of the first carcass cords.

Disclosure 3: The pneumatic tire according to Disclosure 1 or 2, wherein

an insulation rubber layer is disposed between the second carcass cords and the main portions of the first carcass cords.

Disclosure 4: The pneumatic tire according to Disclosure 3, wherein

the insulation rubber layer has a radially outer end located on the radially outside of radially outer ends of the folded-back portions.

Disclosure 5: The pneumatic tire according to Disclosure 4, wherein

the insulation rubber layer has a radially inner end located on the radially inside of the radially outer ends of the folded-back portions.

Disclosure 6: The pneumatic tire according to Disclosure 4, wherein

the insulation rubber layer is disposed axially inside the folded-back portions.

Disclosure 7: The pneumatic tire according to any one of Disclosures 1 to 6, which is used for racing.

Disclosure 8: A method for manufacturing a pneumatic tire comprising a tread portion, a pair of sidewall portions, a pair of bead portions each with an annular bead core embedded therein, and a carcass extending between the bead portions, the method comprising:

a first step of winding a first carcass ply comprising first carcass cords into a cylindrical shape,

a second step of setting the annular bead cores around the cylindrical-shape first carcass ply,

a third step of folding axially outer portions of the first carcass ply around the respective bead cores, and

a fourth step of winding a second carcass ply comprising second carcass cords around the first carcass ply,

wherein
the first carcass cords have a Young's modulus, and the second carcass cords have a Young's modulus larger than the Young's modulus of the first carcass cords.

Disclosure 9: The method for manufacturing a pneumatic tire according to Disclosure 8, which comprises:

a fifth step of winding a tread rubber around the second carcass ply to form a raw tire, and

a sixth step of vulcanization-molding the raw tire,

wherein

in the sixth step, the tread rubber is stretched by 2% to 4% in the circumferential direction of the tire.

### DESCRIPTION OF THE REFERENCE SIGNS

1 pneumatic tire
2 tread portion
3 sidewall portion
4 bead portion
5 bead core
6 carcass
21 tread rubber
61 first carcass ply
62 second carcass ply
63 first carcass cord
63a main portion
63b folded-back portion
64 second carcass cord
65 insulation rubber layer
100 manufacturing method
E1 Young's modulus of first carcass cord
E2 Young's modulus of second carcass cord
S1 first step
S2 second step
S3 third step
S4 fourth step
S5 fifth step
S6 sixth step

1. A pneumatic tire comprising a tread portion, a pair of sidewall portions, a pair of bead portions each with a bead core embedded therein, and a carcass extending between the bead portions and comprising first carcass cords and second carcass cords,
wherein
each of the first carcass cords comprises a main portion extending from the tread portion to the bead portions via the sidewall portions, and folded-back portions continued from the main portion and folded back around the bead cores from the inside to the outside in the tire axial direction,
each of the second carcass cords extends from the tread portion to the bead portions and terminates on the axially outside of the folded-back portions of the first carcass cords,
the first carcass cords have a Young's modulus, and
the second carcass cords have a Young's modulus larger than the Young's modulus of the first carcass cords.

2. The pneumatic tire according to claim 1, wherein
the Young's modulus of the second carcass cords is 1.5 to 2.5 times the Young's modulus of the first carcass cords.

3. The pneumatic tire according to claim 1, wherein
an insulation rubber layer is disposed between the second carcass cords and the main portions of the first carcass cords.

4. The pneumatic tire according to claim 2, wherein
an insulation rubber layer is disposed between the second carcass cords and the main portions of the first carcass cords.

5. The pneumatic tire according to claim 3, wherein
the insulation rubber layer has a radially outer end located on the radially outside of radially outer ends of the folded-back portions.

6. The pneumatic tire according to claim 4, wherein
the insulation rubber layer has a radially outer end located on the radially outside of radially outer ends of the folded-back portions.

7. The pneumatic tire according to claim 5, wherein
the insulation rubber layer has a radially inner end located on the radially inside of the radially outer ends of the folded-back portions.

8. The pneumatic tire according to claim 6, wherein
the insulation rubber layer has a radially inner end located on the radially inside of the radially outer ends of the folded-back portions.

9. The pneumatic tire according to claim 5, wherein
the insulation rubber layer is disposed axially inside the folded-back portions.

10. The pneumatic tire according to claim 6, wherein
the insulation rubber layer is disposed axially inside the folded-back portions.

11. The pneumatic tire according to claim 1, which is used for racing.

12. A method for manufacturing a pneumatic tire comprising a tread portion, a pair of sidewall portions, a pair of bead portions each with an annular bead core embedded therein, and a carcass extending between the bead portions, the method comprising:
a first step of winding a first carcass ply comprising first carcass cords into a cylindrical shape,
a second step of setting the annular bead cores around the cylindrical-shape first carcass ply,
a third step of folding axially outer portions of the first carcass ply around the respective bead cores, and
a fourth step of winding a second carcass ply comprising second carcass cords around the first carcass ply,
wherein
the first carcass cords have a Young's modulus, and the second carcass cords have a Young's modulus larger than the Young's modulus of the first carcass cords.

13. The method for manufacturing a pneumatic tire according to claim 12, which comprises:
a fifth step of winding a tread rubber around the second carcass ply to form a raw tire, and
a sixth step of vulcanization-molding the raw tire,
wherein
in the sixth step, the tread rubber is stretched by 2% to 4% in the circumferential direction of the tire.
